(19) United States
(12) Patent Application Publication
(10) Pub. No.: US 2022/0376901 A1
(43) Pub. Date: Nov. 24, 2022

(54) CYPHER SYSTEM, KEY GENERATION APPARATUS, ENCRYPTION APPARATUS, DECRYPTION APPARATUS, METHOD AND PROGRAM

(71) Applicant: NIPPON TELEGRAPH AND TELEPHONE CORPORATION, Tokyo (JP)

(72) Inventor: Junichi TOMIDA, Tokyo (JP)

(73) Assignee: NIPPON TELEGRAPH AND TELEPHONE CORPORATION, Tokyo (JP)

(21) Appl. No.: 17/622,208

(22) PCT Filed: Jul. 10, 2019
(86) PCT No.: PCT/JP2019/027330

§ 371 Date: Dec. 22, 2021

(51) Int. Cl. H04L 9/08

(52) U.S. Cl. CPC H04L 9/0825; H04L 9/0861

(57) ABSTRACT

An encryption system includes one or more computers each including a memory and a processor configured to generating a public key and a master private key that are used in attribute-based encryption; using, as inputs, at least the public key and one of an attribute and a policy that is denoted by an arbitrary conditional expression related to the attribute, and generating at least cyphertext in which one of the attribute and the policy is embedded; using the public key, the master private key, and the other of the attribute and the policy as inputs, and generating a private key in which the other of the attribute and the policy is embedded; and using the public key, the cyphertext, and the private key as inputs, and decrypting the cyphertext.

### TECHNICAL FIELD

The present invention relates to an encryption system, a key generation apparatus, an encryption apparatus, a decryption apparatus, a method, and a program.

### BACKGROUND ART

Attribute-based encryption is known as an encryption method that allows complex decryption control. Attribute-based encryption is categorized mainly into two types: key-policy attribute-based encryption and ciphertext-policy attribute-based encryption. In key-policy attribute-based encryption, information of an attribute is embedded in cyphertext in addition to plaintext, and a policy (something like a conditional expression for the attribute) is embedded in a private key. When the cyphertext is decrypted using the private key, the decryption can be performed only when the attribute embedded in the cyphertext satisfies the policy embedded in the private key. On the other hand, in ciphertext-policy attribute-based encryption, which is the opposite of key-policy attribute-based encryption, a policy is embedded in cyphertext, and information of an attribute is embedded in a private key.

One of the important characteristics of attribute-based encryption is the expressiveness of a policy. The expressiveness of a policy generally refers to how finely decryption conditions can be described. The more finely a policy can describe decryption conditions, the higher the expressiveness of the policy is. In general, a policy is often denoted by a Boolean formula. For example, a policy is denoted by “(position=department manager) AND (department=general administration department)” and the like. This represents a policy that permits decryption only when an attribute of a department manager is held as a position and an attribute of a general administration department is held as a department.

One of the items related to the expressiveness of a policy is whether NOT can be handled in a conditional expression. That is to say, this item is about, for example, whether a conditional expression “(position=department manager) AND (department≠general administration department)” can be handled. A method called OT is known as an encryption method with which a conditional expression that includes NOT in the foregoing manner can be expressed, and with which no restriction is placed on the magnitude of an attribute set and a policy in the method.

### CITATION LIST

### Non Patent Literature

[NPL 1] Okamoto T., Takashima K. (2012) Fully Secure Unbounded Inner-Product and Attribute-Based Encryption. In: Wang X., Sako K. (eds) Advances in Cryptology—ASIACRYPT 2012. ASIACRYPT 2012. Lecture Notes in Computer Science, vol 7658. Springer, Berlin, Heidelberg

### SUMMARY OF THE INVENTION

### Technical Problem

While the OT method is excellent in high expressiveness and in that no restriction is placed on the magnitude of an attribute set and a policy, there are cases where the OT method is inefficient in operation and requires time in key generation processing, encryption processing, decryption processing, and the like. Attribute-based encryption has a potential of application to smartphones and the like, and desirably operates in a practical period of time even on a device that has relatively small calculation resources.

Furthermore, in order to allow handling a policy that includes a large number of same attribute labels, it is necessary in the OT method to increase the number of elements on the side with embedded attributes in proportion to the maximum value of the number of appearances of the same attribute labels. For example, regarding a conditional expression “((position=department manager) AND (department=general administration department)) OR ((position=group manager) AND (department=accounting department))”, an attribute label “position” and an attribute label “department” are included twice each in this conditional expression. In order to allow handling such a conditional expression, it is necessary to double the magnitude (size) of cyphertext in key-policy attribute-based encryption (a private key in ciphertext-policy attribute-based encryption) compared to the original OT method. In order to allow handling a conditional expression in which the same attribute labels appear a larger number of times, it is necessary to further increase the size of cyphertext or a private key.

With the foregoing in view, it is an object of an embodiment of the present invention to implement efficient attribute-based encryption that can use an arbitrary conditional expression as a policy without increasing the size of cyphertext and a private key.

### Means for Solving the Problem

To achieve the aforementioned object, an encryption system according to the present embodiment includes: setup means for generating a public key and a master private key that are used in attribute-based encryption; encryption means for using, as inputs, at least the public key and one of an attribute and a policy that is denoted by an arbitrary conditional expression related to the attribute, and generating at least cyphertext in which one of the attribute and the policy is embedded; key generation means for using the public key, the master private key, and the other of the attribute and the policy as inputs, and generating a private key in which the other of the attribute and the policy is embedded; and decryption means for using the public key, the cyphertext, and the private key as inputs, and decrypting the cyphertext.

### Effects of the Invention

It is possible to implement efficient attribute-based encryption that can use an arbitrary conditional expression as a policy without increasing the size of cyphertext and a private key.

### BRIEF DESCRIPTION OF DRAWINGS

FIG. 1 is a diagram showing an example of an overall configuration of an encryption system according to the present embodiment.

FIG. 2 is a diagram showing an example of a hardware configuration of a key generation apparatus, an encryption apparatus, and a decryption apparatus according to the present embodiment.

### DESCRIPTION OF EMBODIMENTS

The following describes an embodiment of the present invention (hereinafter also referred to as “the present embodiment”). The present embodiment will be described in relation to an encryption system 1 which can use an arbitrary conditional expression as a policy without increasing the size of cyphertext and a private key, and which implements attribute-based encryption that operates efficiently.

<Preparation>

First, the notation, concept, and the like necessary for the description of the present embodiment will be explained.

Notation

Denoting a prime number by p, a field Z/pZ is denoted by Zₚ. A set of all bit strings each having a finite length is denoted by {0,1}*. For example, denoting a natural number by n, a set of all bit strings having a length of n is denoted by {0,1}ⁿ.

For a natural number n, {1, . . . , n} is denoted by [n]. Denoting a set by S, selecting s uniformly from the set S is denoted by s←S. For matrices A₁ and A₂ having the same number of rows, a concatenation of A₁ and A₂ is denoted as follows.

(A₁∥A₂) [Math 1]

A space spanned by all columns of the matrix A (i.e., a space having the column vectors constituting the matrix Z as the base) is denoted by span(A).

Let i∈{1,2,T}, a matrix on a cyclic group Gᵢ having an order p with respect to a matrix A:=(a_{j,l})_{j,l} on Zₚ that has the following element (j,l), is denoted by [A]ᵢ.

[Math 2] [symbol]
Note that this notation is similarly applied to vectors and scalars. Furthermore, ([A]₁,[A]₂) is denoted by [A]_{1,2}.

Regarding matrices A and B for which

[symbol]

B [Math 3]

is defined, pairing is denoted as follows, albeit an overly-used notation.

e([A]₁,[B]₂)=[ [symbol] B]^{T} [Math 4]

Note that the following denotes transposition.

[symbol]

[Math 5]

Boolean Formula

A Boolean formula is an expression in which Boolean variables are connected by “AND”, “OR”, and “NOT”. A Boolean formula can easily be converted into a logic circuit with fan-in of 2 and fan-out of 1. A Boolean formula that does not include NOT is referred to as a monotone Boolean formula, whereas a Boolean formula that includes NOT is referred to as a non-monotone Boolean formula. In the present embodiment, it is assumed that a Boolean formula is represented as a logic circuit.

Attribute and Policy

In the present embodiment, a set of attributes is defined by the following expression (1).

[Math 6]

χ= [symbol] ×Φᵢ (1)

Here, Φᵢ denotes a set composed of all injective functions φ: [i]→{0,1}*.

Also, a set of policies is defined by the following expression (2).

[Math 7]

y= [symbol] × [symbol] ᵢ×Ψᵢ× [symbol] (2)

Here,

### [Math 8]

Fᵢ is a set composed of all monotone Boolean formulae with an input length of i,
Ψᵢ is a set composed of all functions ψ:[i]→{0,1}*, and
Tᵢ is a set composed of all functions t:[i]→{0,1}.

In attribute-based encryption described in the present embodiment, each attribute is an element of a set defined by the aforementioned expression (1), and each policy is an element of a set defined by the aforementioned expression (2).

Furthermore, when an attribute

x=(x∈ [symbol] ₚ^{m},ϕ) [Math 9]

satisfies a policy

y=(y∈ [symbol] ₚⁿ,f,ψ,t), [Math 10]

it means that f(b)=1 holds for b defined by the following expression (3). That is to say, decryption can be performed only when f(b)=1.

For an attribute x and a policy y, b=(b₁, . . . , bₙ)∈{0,1}ⁿ is defined by the following expression (3).

$$\begin{matrix}[ Math 11 ] & \\ {b}_{i} := \{ \begin{matrix}t ( i ) ⊙ true ( {x}_{{ϕ}^{- 1} ( ψ ( i ) )} = {y}_{i} ) & ψ ( i ) ⊆ Im ( ϕ ) \\ 0 & ψ ( i ) ⊈ Im ( ϕ )\end{matrix} & ( 3 )\end{matrix}$$

### Here,

⊙ [Math 12]

denotes exclusive NOR (XNOR), and true denotes a truth value. Furthermore, xⱼ is the j^{th} element of

x∈ [symbol] ₚ^{m}, [Math 13]

and yᵢ is the i^{th} element of

y∈ [symbol] ₚ^{m}. [Math 14]

Note that the aforementioned expression (1) and expression (2) are notations for the case of key-policy attribute-based encryption; in ciphertext-policy attribute-based encryption, the contents of definitions of a set of attributes and of a set of policies are reversed.

Linear Secret Sharing

In the present embodiment, a linear secret sharing scheme is used. The linear secret sharing scheme is a scheme in which a secret vector k is allocated and split into σ₁, . . . , σₙ in accordance with a certain function f{0,1}ⁿ→{0,1}. The original secret vector k can be restored by collecting, from among the split allocations, allocations corresponding to a portion having a bit 1 in a bit string b that satisfies f(b)=1. That is to say, there is a set S that can easily be calculated from f and b, and k can be restored by simply adding the allocations as follows.

k=Σ_{i∈S}σᵢ [Math 15]

On the other hand, k cannot be restored by collecting allocations corresponding to a portion with a bit 1 in a bit string b that satisfies f(b)=0.

The linear secret sharing scheme is implemented by algorithms shown in the following (S1) to (S4). Here, the inputs into the linear secret sharing scheme are a monotone Boolean formula f:{0,1}ⁿ→{0,1}, and a secret vector

k∈ [symbol] . [Math 16]

Hereinafter, an algorithm in this linear secret sharing scheme is also referred to as “Share”.

(S1) A vector σₒᵤₜ:=k is set to an output line of a monotone Boolean formula f represented by a logic circuit (i.e., an output line of this logic circuit).

(S2) Assuming that each AND gate in this logic circuit has input lines a and b and an output line c, a vector

u_{g}← [symbol] [Math 17]

is selected with respect to each AND gate with the output line c for which a vector σ_{c} is set, and then, a vector σₐ:=σ_{c}−u_{g} and a vector σ_{b}:=u_{g} are respectively set to the input line a and the input line b.

(S3) Assuming that each OR gate in this logic circuit has input lines a and b and an output line c, and with respect to each OR gate with the output line c to which a vector σₙ is set, vectors σₐ:=σ_{c} and σ_{b}:=σ_{c} are respectively set to the input line a and the input line b.

(S4) σ₁, . . . , σₙ that have been set to the input lines 1, . . . , n of the monotone Boolean formula f (i.e., the input lines 1, . . . , n of this logic circuit) are output as allocations for the secret vector k.

Note that an algorithm Share in this linear secret sharing is similarly applicable also to vectors of group elements.

### Attribute-Based Encryption According to Present Embodiment

Key-policy attribute-based encryption according to the present embodiment and ciphertext-policy attribute-based encryption according to the present embodiment will be described as attribute-based encryption according to the present embodiment. The attribute-based encryption is composed of four algorithms (i.e., a setup algorithm Setup, an encryption algorithm Enc, a key generation algorithm KeyGen, and a decryption algorithm Dec). In the present embodiment, cyclic groups having bilinear mappings e:G₁×G₂→G_{T} are used as cyclic groups G₁, G₂, and G_{T} of an order p of a prime number. These cyclic groups and the bilinear mappings are collectively referred to as bilinear groups. Known bilinear groups may be used, or bilinear groups may be generated using the setup algorithm Setup.

Notations of Matrices

First, notations of matrices used in the description of each algorithm in attribute-based encryption, and in the description of each algorithm in later-described attribute-based KEM (Key Encapsulation Mechanism), will be described.

It is assumed that k is an arbitrary natural number, and

[symbol]

ₖ [Math 18]

is an appropriate set of matrices of (k+1)×k on Zₚ that have full rank. At this time, A*, a_{R}, and a^{⊥} are defined with respect to

A∈ [symbol] ₖ, [Math 19]

as follows. That is, it is assumed that a_{R} is a vector which is calculated definitely from the matrix A by a certain, determined method, and has

Ā:=(A∥a_{R}) [Math 20]

as the base. Furthermore, it is assumed that A* is a matrix composed of k columns from the left (i.e., columns from the first column to the k^{th} column) of

( [symbol] )⁻¹, [Math 21]

and a vector al is the rightmost column of

( [symbol] )⁻¹. [Math 22]

For these A*, a_{R}, and a^{⊥}, the following relationship is satisfied.

[symbol]

A*=Iₖ, [symbol] a^{⊥}=0,A* [symbol] + [symbol] =Iₖ₊₁ [Math 23]

Here, Iₖ is a unit matrix of k×k, and Iₖ₊₁ is a unit matrix of (k+1)×(k+1).

Also, it is assumed that a matrix B, a vector b₁, and a vector b₂ are respectively a matrix composed of k columns from the left of the following matrix, a vector representing the (k+1)^{th} column of the following matrix, and a vector representing the rightmost column (i.e., the (k+2)^{th} column) of the following matrix.

B̅∈GLₖ₊₂( [symbol] ₚ) [Math 24]

Here, GLₖ₊₂(Zₚ) is a set of all regular matrices of (k+2)×(k+2) on Zₚ (i.e., a general linear group having a size k+2 on Zₚ).

Similarly, it is assumed that a matrix B*, a vector b₁*, and a vector b₂* are respectively a matrix composed of k columns from the left of the following matrix, a vector representing the (k+1)^{th} column of the following matrix, and a vector representing the rightmost column of the following matrix.

( [symbol] )⁻¹ [Math 25]

Note that, for simplicity,

(b₁∥b₂) [Math 26]

is also denoted by B₁₂. This notation is similarly applied to other cases as well (e.g., the case of matrices or the like).

Key-Policy Attribute-Based Encryption According to Present Embodiment

The following describes the respective algorithms in key-policy attribute-based encryption according to the present embodiment. It is assumed that k is an arbitrary natural number, and

H:{0,1}*→G₁^{(k+1)×k}×G₁^{(k+1)×k} [Math 27]

is a function. Furthermore, it is assumed that

F_{K}:{0,1}*→ [symbol] ₚ^{k+1}× [symbol] ₚ^{k+1} [Math 28]

is a family of functions with an index K, and

[symbol]

[Math 29]

is an index space of K. At this time, the setup algorithm Setup, the encryption algorithm Enc, the key generation algorithm KeyGen, and the decryption algorithm Dec in key-policy attribute-based encryption according to the present embodiment are configured as follows.

Setup( ): The setup algorithm Setup outputs a public key pk and a master private key msk as follows.

A,B← [symbol] ₖ,k← [symbol] ₚ^{k+1},K← [symbol] ,

pk:( [symbol] ,[A]₂,[ [symbol] k]_{T}),msk:(A*,a^{⊥},B,k,K) [Math30]

Here, G denotes bilinear groups, and G:=(p, G₁, G₂, G_{T}, g₁, g₂, e). Also, g₁ and g₂ are generators of G₁ and G₂, respectively. As stated earlier, known bilinear groups G may be used, or bilinear groups G may be generated using the setup algorithm Setup.

Enc (pk, x, M): The encryption algorithm Enc takes a public key pk, an attribute

x=(x∈ [symbol] ₚ^{m},ϕ), [Math 31]

and a message MEG_{T} as inputs, and outputs cyphertext ctₓ (cyphertext ctₓ with an attribute) as follows.

s← [symbol] ₚ^{k},([U_{ϕ(i),0}]₁,[U_{ϕ)(i),1}]₁):=H(ϕ(i)),

c₁:=[As]₂,c_{2,i}:=[(xᵢU_{ϕ(i),0}+U_{ϕ(i),1})s]₁,

c₃:=[s [symbol] k]_{T}M for i∈[m],

ctₓ:=(x,c₁,{c_{2,i}}_{i∈[m]},c₃) [Math 32]

KeyGen (pk, msk, y): The key generation algorithm KeyGen takes a public key pk, a master private key msk, and a policy

y=(y∈ [symbol] ₚⁿ,f,Φ,t) [Math 33]

as inputs, and outputs a private key sk_{y} (a private key sk_{y} with a policy) as follows.

$$\begin{matrix}[ Math 34 ] & \\ \begin{matrix}{r}_{1} , … , {r}_{d} ← {ℤ}_{p}^{k} , {k}_{1} , … , {k}_{n} ← Share ( f , k ) ∈ {ℤ}_{p}^{k + 1} , \\ {{k}_{1 , j} := [ {Br}_{j} \vert}_{2} for j ∈ [ d ] , \\ ( {[ {U}_{ψ ( i ) , 0} ]}_{1} , {[ {U}_{ψ ( i ) , 1} ]}_{1} ) := H ( ψ ( i ) ) , ( {u}_{ψ ( i ) , 0} , {u}_{ψ ( i ) , 1} ) := {F}_{K} ( ψ ( i ) ) , \\ {k}_{2 , i} := {[ {k}_{i} + {A}^{*} ( {y}_{i} {U}_{ψ ( i ) , 0}^{⊤} + {U}_{ψ ( i ) , 1}^{⊤} ) {Br}_{π ( i )} + {a}^{⊥} ( {y}_{i} {u}_{ψ ( i ) , 0}^{⊤} + {u}_{ψ ( i ) , 1}^{⊤} ) {Br}_{π ( i )} ]}_{1} if t ( i ) = 1 , \\ {k}_{2 , i} := ( {k}_{2 , i , 1} , {k}_{2 , i , 2} ) := ( \begin{matrix}{[ - {k}_{i} + {A}^{*} {U}_{ψ ( i ) , 0}^{⊤} {Br}_{π ( i )} + {a}^{⊥} {u}_{ψ ( i ) , 0}^{⊤} {Br}_{π ( i )} ]}_{1} , \\ {[ {y}_{i} {k}_{i} + {A}^{*} {U}_{ψ ( i ) , 1}^{⊤} {Br}_{π ( i )} + {a}^{⊥} {u}_{ψ ( i ) , 1}^{⊤} {Br}_{π ( i )} ]}_{1}\end{matrix} ) if t ( i ) = 0 \\ for i ∈ [ n ] \\ {sk}_{y} := ( y , {\{ {k}_{1 , j} \}}_{j ∈ [ d ]} , {\{ {k}_{2 , i} \}}_{i ∈ [ n ]} )\end{matrix} & \end{matrix}$$

Here, π:[n]→{n|n is a natural number} is a function defined as π(i):=|{j|ω(j)=ψ(i), j≤i}|, and d is the maximum value of the number of appearances of the same attribute label in f (i.e., d:=max_{i∈[n]}π(i)).

Dec (pk, ctₓ, sk_{y}): The decryption algorithm Dec takes a public key pk, cyphertext ctₓ, and a private key sk_{y} as inputs, calculates b from x and y by the aforementioned expression (3), and then, outputs ⊥ indicating a decryption failure when f(b)=0. On the other hand, when f(b)≠0, the decryption algorithm Dec calculates a set S⊆{i|bᵢ=1} that satisfies

k=Σ_{i∈S}kᵢ [Math 35]

and outputs M′ as follows.

$$\begin{matrix}[ Math 36 ] & \\ \begin{matrix}{D}_{1 , j} := e ( {{\sum }_{π ( i ) = j}}_{i ∈ {S}_{1}} {k}_{2 , i} + {{\sum }_{π ( i ) = j}}_{i ∈ {S}_{0}} \frac{1}{{y}_{i} - {x}_{{ϕ}^{- 1} ( ψ ( i ) )}} ( {x}_{{ϕ}^{- 1} ( ψ ( i ) )} {k}_{2 , i , 1} + {k}_{2 , i , 2} ) , {c}_{1} ) , \\ {D}_{2 , j} := e ( {{\sum }_{π ( i ) = j}}_{i ∈ {S}_{1}} {c}_{2 , {ϕ}^{- 1} ( ψ ( i ) )} + {{\sum }_{π ( i ) = j}}_{i ∈ {S}_{0}} \frac{1}{{y}_{i} - {x}_{{ϕ}^{- 1} ( ψ ( i ) )}} {c}_{2 , {ϕ}^{- 1} ( ψ ( i ) )} , {k}_{1 , j} ) for j ∈ [ d ] , \\ {M}^{′} := {c}_{3} / {\prod }_{j ∈ [ d ]} ( {D}_{1 , j} / {D}_{2 , j} )\end{matrix} & \end{matrix}$$

Here, S₁:=S∩{i|t(i)=1} and S₀:=S∩{i|t(i)=0}.

Ciphertext-Policy Attribute-Based Encryption According to Present Embodiment

The following describes the respective algorithms in ciphertext-policy attribute-based encryption according to the present embodiment. It is assumed that k is an arbitrary natural number, GLₖ(Zₚ) is a general linear group with a size k on Zₚ, and

H:{0,1}*→G₁^{(k+1)×k}×G₁^{(k+1)×k} [Math 37]

is a function. Also, it is assumed that

F_{K}:{0,1}*→ [symbol] ₚ^{k+2}× [symbol] ₚ^{k+2} [Math 38]

is a family of functions with an index K, and

[symbol]

[Math 39]

is an index space of K. At this time, the setup algorithm Setup, the encryption algorithm Enc, the key generation algorithm KeyGen, and the decryption algorithm Dec in ciphertext-policy attribute-based encryption according to the present embodiment are configured as follows.

Setup( ): The setup algorithm Setup outputs a public key pk and a master private key msk as follows.

A← [symbol] ₖ, [symbol] ←GLₖ₊₂( [symbol] ₚ),W← [symbol] ₚ^{(k+1)×(k+2)},

k← [symbol] ₚ^{k+2},K←,

pk:=( [symbol] ,[B]₂,[WB]₁,[ [symbol] k]_{T}),

msk:=(A, [symbol] A,B*,B₁₂*,k,K) [Math 40]

Here, G denotes bilinear groups, and G:=(p, G₁, G₂, G_{T}, g₁, g₂, e). As stated earlier, known bilinear groups G may be used, or bilinear groups G may be generated using the setup algorithm Setup.

Enc (pk, x, M): The encryption algorithm Enc takes a public key pk, a policy

x=(x∈ [symbol] ₚⁿ,f,ψ,t), [Math 41]

and a message MEG_{T} as inputs, and outputs cyphertext ctₓ (cyphertext ctₓ with a policy) as follows.

r,r₁, . . . ,r_{d}← [symbol] ₚ^{k},[w₁]₁, . . . ,[wₙ]₁←Share(f,[WBr]₁)∈ [symbol] ₚ^{k+1},

c₁:=[Br]₂,c_{2,j}:=[Brⱼ]₂ for j∈[d],c₄:=[ [symbol] k]_{T}M,

([U_{ψ(i),0}]₁,[U_{ψ(i),1}]₁):=H(ψ(i)),

c_{3,i}:=[wᵢ+(xᵢU_{ψ(i),0}+U_{ψ(i),1})r_{π(i)}]₁ if t(i)=1,

c_{3,i}:=(c_{3,i,1},c_{3,i,2}):=([−wᵢ+U_{ψ(i),0}r_{π(i)}]₁,[xᵢw₁+U_{ψ(i),1}r_{π(i)}]₁ if t(i)=0

for i∈[n],

ctₓ:=(x,c₁,{c_{2,j}}_{j∈[d]},{c_{3,i}}_{i∈[n]},c₄) [Math 42]

Here, π:[n]→{n|n is a natural number} is a function defined as to π(i):=|{j|ψ(j)=ψ(i), j≤i}|, and d is the maximum value of the number of appearances of the same attribute label in f (i.e., d:=max_{i∈[x]}π(i)).

KeyGen (pk, msk, y): The key generation algorithm KeyGen takes a public key pk, a master private key msk, and an attribute

y=(y∈ [symbol] ₚ^{m},ϕ) [Math 43]

as inputs, and outputs a private key sk_{y} (a private key sk_{y} with an attribute) as follows.

s← [symbol] ₚ^{k},([U_{ϕ(i),0}]₁,[U_{ϕ(i),1}]₁):=H(ϕ(i)),(V_{ϕ(i),0},V_{ϕ(i),1}):=F_{K}(ϕ(i))

k₁:=[As]₂,k₂:=[k+W^{T} As]₁,

k_{3,i}:=[B [symbol] + [symbol] As+B₁₂*(yᵢ [symbol] ₊ [symbol] ₎As]₁ for i∈[m],

sk_{y}:=(y,k₁,k₂,{k_{3,i}}_{i∈[m]}) [Math 44]

Dec (pk, ctₓ, sk_{y}): The decryption algorithm Dec takes a public key pk, cyphertext ctₓ, and a private key sk_{y} as inputs, calculates b from x and y by the aforementioned expression (3), and then outputs ⊥ indicating a decryption failure when f(b)=0. On the other hand, when f(b)≠0, the decryption algorithm Dec calculates a set S⊆{i|bᵢ=1} that satisfies.

WBr=Σ_{i∈S}wᵢ [Math 45]

and outputs M′ as follows.

$$\begin{matrix}[ Math 46 ] & \\ \begin{matrix}{D}_{1 , j} := e ( {{\sum }_{π ( i ) = j}}_{i ∈ {S}_{1}} {c}_{3 , i} + {{\sum }_{π ( i ) = j}}_{i ∈ {S}_{0}} \frac{1}{{x}_{i} - {y}_{{ϕ}^{- 1} ( ψ ( i ) )}} ( {y}_{{ϕ}^{- 1} ( ψ ( i ) )} {c}_{3 , i , 1} + {c}_{3 , i , 2} ) , {k}_{1} ) , \\ {D}_{2 , j} := e ( {{\sum }_{π ( i ) = j}}_{i ∈ {S}_{1}} {k}_{3 , {ϕ}^{- 1} ( ψ ( i ) )} + {{\sum }_{π ( i ) = j}}_{i ∈ {S}_{0}} \frac{1}{{x}_{i} - {y}_{{ϕ}^{- 1} ( ψ ( i ) )}} {k}_{3 , {ϕ}^{- 1} ( ψ ( i ) )} , {c}_{2 , j} ) for j ∈ [ d ] , \\ {M}^{′} := {c}_{4} / ( e ( {k}_{2} , {c}_{1} ) / {\prod }_{j ∈ [ d ]} ( {D}_{1 , j} / {D}_{2 , j} ) )\end{matrix} & \end{matrix}$$

Here, S₁:=S∩{i|t(i)=1}, S₀:=S∩{i|t(i)=0}.

### Attribute-Based KEM According to Present Embodiment

The aforementioned key-policy attribute-based encryption and ciphertext-policy attribute-based encryption according to the present embodiment are also applicable to a KEM method. In general, public key encryption techniques are slow in operation; thus, when large-volume data is encrypted, it is often the case that a private key used in common-key encryption is delivered safely using public key encryption, and the data is encrypted using common-key encryption. A method used to safely deliver a private key of common-key encryption (hereinafter also referred to as a “common key”) is called KEM.

In view of this, the following describes key-policy attribute-based KEM in which key-policy attribute-based encryption according to the present embodiment is applied to KEM, as well as cyphertext-policy attribute-based KEM in which ciphertext-policy attribute-based encryption according to the present embodiment is applied to KEM.

Key-Policy Attribute-Based KEM According to Present Embodiment

The following describes the respective algorithms in key-policy attribute-based KEM according to the present embodiment. It is assumed that a function H and a family of functions F_{K} are similar to those of “key-policy attribute-based encryption according to the present embodiment” described earlier, and

H₂:G_{T}→ [symbol] [Math 47]

is a function. Here,

[symbol]

[Math 48]

is a private key space of common-key encryption. At this time, the setup algorithm Setup, the encryption algorithm Enc, the key generation algorithm KeyGen, and the decryption algorithm Dec in key-policy attribute-based KEM according to the present embodiment are configured as follows.

Setup( ): The setup algorithm Setup outputs a public key pk and a master private key msk as follows.

A,B← [symbol] ₖ,k← [symbol] ₚ^{k+1},K←K,

pk:=( [symbol] ,[A]₂,[ [symbol] k]_{T}),msk:=(A*,a^{⊥},B,k,K) [Math 49]

Here, G denotes bilinear groups, and G:=(p, G₁, G₂, G_{T}, g₁, g₂, e). As stated earlier, known bilinear groups G may be used, or bilinear groups G may be generated using the setup algorithm Setup.

Enc (pk, x): The encryption algorithm Enc takes a public key pk and an attribute

X=(x∈ [symbol] ₚ^{m},ϕ) [Math 50]

as inputs, and outputs cyphertext ctₓ (cyphertext ctₓ with an attribute) and a common key L as follows.

s← [symbol] ₚ^{k},([U_{ϕ(i),0}]₁,[U_{ϕ(i),1}]₁):=H(ϕ(i)),

c₁:=[As]₂,c_{2,i}:=[(xᵢU_{ϕ(i),0}+U_{ϕ(i),1})s]₁,

L:=H₂([ [symbol] k]_{T}) for i∈[m],

ctₓ:=(x,c₁,{c_{2,i}}_{i∈[m]}) [Math 51]

KeyGen (pk, msk, y): The key generation algorithm KeyGen takes a public key pk, a master private key msk, and a policy

y=(y∈ [symbol] ₚⁿ,f,ψ,t) [Math 52]

as inputs, and outputs a private key sk_{y} (a private key sk_{y} with a policy) as follows.

$$\begin{matrix}[ Math 53 ] & \\ \begin{matrix}{r}_{1} , … , {r}_{d} ← {ℤ}_{p}^{k} , {k}_{1} , … , {k}_{n} ← Share ( f , k ) ∈ {ℤ}_{p}^{k + 1} , \\ {k}_{1 , j} := {[ {Br}_{j} ]}_{2} for j ∈ [ d ] , \\ ( {[ {U}_{ψ ( i ) , 0} ]}_{1} , {[ {U}_{ψ ( i ) , 1} ]}_{1} ) := H ( ψ ( i ) ) , ( {u}_{ψ ( i ) , 0} , {u}_{ψ ( i ) , 1} ) := {F}_{K} ( ψ ( i ) ) , \\ {k}_{2 , i} := {[ {k}_{i} + {A}^{*} ( {y}_{i} {U}_{ψ ( i ) , 0}^{⊤} + {U}_{ψ ( i ) , 1}^{⊤} ) {Br}_{π ( i )} + {a}^{⊥} ( {y}_{i} {u}_{ψ ( i ) , 0}^{⊤} + {u}_{ψ ( i ) , 1}^{⊤} ) {Br}_{π ( i )} ]}_{1} if t ( i ) = 1 , \\ {k}_{2 , i} := ( {k}_{2 , i , 1} , {k}_{2 , i , 2} ) := ( \begin{matrix}{[ - {k}_{i} + {A}^{*} {U}_{ψ ( i ) , 0}^{⊤} {Br}_{π ( i )} + {a}^{⊥} {u}_{ψ ( i ) , 0}^{⊤} {Br}_{π ( i )} ]}_{1} , \\ {[ {y}_{i} {k}_{i} + {A}^{*} {U}_{ψ ( i ) , 1}^{⊤} {Br}_{π ( i )} + {a}^{⊥} {u}_{ψ ( i ) , 1}^{⊤} {Br}_{π ( i )} ]}_{1}\end{matrix} ) if t ( i ) = 0 \\ for i ∈ [ n ] \\ {sk}_{y} := ( y , {\{ {k}_{1 , j} \}}_{j ∈ [ d ]} , {\{ {k}_{2 , i} \}}_{i ∈ [ n ]} )\end{matrix} & \end{matrix}$$

Here, π:[n]→{n|n is a natural number} is a function defined as π(i):=|{j|ω(j)=ψ(i), j≤i}|, and d is the maximum value of the number of appearances of the same attribute label in f (i.e., d:=max_{i∈[n]}π(i)).

Dec (pk, ctₓ, sk_{y}): The decryption algorithm Dec takes a public key pk, cyphertext ctₓ, and a private key sk_{y} as inputs, calculates b from x and y by the aforementioned expression (3), and then outputs ⊥ indicating a decryption failure when f(b)=0. On the other hand, when f(b)≠0, the decryption algorithm Dec calculates a set S⊆{i|bᵢ=1} that satisfies

k=Σ_{i∈S}kᵢ [Math 54]

and outputs a common key L′ as follows.

$$\begin{matrix}[ Math 55 ] & \\ \begin{matrix}{D}_{1 , j} := e ( {{\sum }_{π ( i ) = j}}_{i ∈ {S}_{1}} {k}_{2 , i} + {{\sum }_{π ( i ) = j}}_{i ∈ {S}_{0}} \frac{1}{{y}_{i} - {x}_{{ϕ}^{- 1} ( ψ ( i ) )}} ( {x}_{{ϕ}^{- 1} ( ψ ( i ) )} {k}_{2 , i , 1} + {k}_{2 , i , 2} ) , {c}_{1} ) , \\ {D}_{2 , j} := e ( {{\sum }_{π ( i ) = j}}_{i ∈ {S}_{1}} {c}_{2 , {ϕ}^{- 1} ( ψ ( i ) )} + {{\sum }_{π ( i ) = j}}_{i ∈ {S}_{0}} \frac{1}{{y}_{i} - {x}_{{ϕ}^{- 1} ( ψ ( i ) )}} {c}_{2 , {ϕ}^{- 1} ( ψ ( i ) ) ,} {k}_{1 , j} ) for j ∈ [ d ] , \\ {L}^{′} := {H}_{2} ( {\prod }_{j ∈ [ d ]} ( {D}_{1 , j} / {D}_{2 , j} ) )\end{matrix} & \end{matrix}$$

Here, S₁:=S∩{i|t(i)=1}, S₀:=S∩{i|t(i)=0}.

Cyphertext-Policy Attribute-Based KEM According to Present Embodiment

The following describes the respective algorithms in cyphertext-policy attribute-based KEM according to the present embodiment. It is assumed that a function H and a family of functions F_{K} are similar to those of “ciphertext-policy attribute-based encryption according to the present embodiment” described earlier, and

H₂:G_{T}→ [symbol] [Math 56]

is a function. Here,

[symbol]

[Math 57]

is a private key space of common-key encryption. At this time, the setup algorithm Setup, the encryption algorithm Enc, the key generation algorithm KeyGen, and the decryption algorithm Dec in cyphertext-policy attribute-based KEM according to the present embodiment are configured as follows.

Setup( ): The setup algorithm Setup outputs a public key pk and a master private key msk as follows.

B̅←GLₖ₊₂( [symbol] ₚ), W← [symbol] ₚ^{(k+1)×(k+2)},k← [symbol] ₚ^{k+2},K←K,

pk:=(G,[B]₂, [WB]₁,[ [symbol] k]_{T}),

msk:=(A,W^{T} A,B*,B₁₂*,k,K) [Math 58]

Here, G denotes bilinear groups, and G:=(p, G₁, G₂, G_{T}, g₁, g₂, e). As stated earlier, known bilinear groups G may be used, or bilinear groups G may be generated using the setup algorithm Setup.

Enc (pk, x): The encryption algorithm Enc takes a public key pk and a policy

x=(x∈ [symbol] ₚⁿf,ψ,t) [Math 59]

as inputs, and outputs cyphertext ctₓ (cyphertext ctₓ with a policy) and a common key L as follows.

r,r₁, . . . ,r_{d}← [symbol] ₚ^{k},[w₁]₁, . . . ,[wₙ]₁←Share(f,[WBr]₁)∈ [symbol] ₚ^{k+1},

c₁:=[Br]₂,c_{2,j}:=[Brⱼ]₂ for j∈[d],L:=H₂([ [symbol] k]_{T}),

([U_{ψ(i),0}]₁,[U_{ψ(i),1}]₁):=H(ψ(i)),

c_{3,i}:=[wᵢ+(xᵢU_{ψ(i),0}+U_{ψ(i),1})r_{π(i)}]₁ if t(i)=1,

c_{3,i}:=(c_{3,i,1},c_{3,i,2}):=([−wᵢ+U_{ψ(i),0}r_{π(i)}]₁,[xᵢwᵢ+U_{ψ(i),1}r_{π(i)}]₁) if t(i)=0

for i∈[n],

ctₓ:=(x,c₁,{c_{2,j}}_{j∈[d]},{c_{3,i}}_{i∈[n]}) [Math 60]

Here, π:[n]→{n|n is a natural number} is a function defined as π(i):=|{j|ψ(j)=ψ(i), j≤i}|, and d is the maximum value of the number of appearances of the same attribute label in f (i.e., d:=max_{i∈[n]}π(i)).

KeyGen (pk, msk, y): The key generation algorithm KeyGen takes a public key pk, a master private key msk, and an attribute

y=(y∈ [symbol] ₚ^{m},ϕ) [Math 61]

as inputs, and outputs a private key sk_{y} (a private key sk_{y} with an attribute) as follows.

s← [symbol] ₚ^{k},([U_{ϕ(i),0}]₁,[U_{ϕ(i),1}]₁):=H(ϕ(i)),(V_{ϕ(i),0},V_{ϕ(i),1}):=F_{K}(ϕ(i))

k₁:=[As]₂,k₂:=[k+W^{T} As]₁,

k_{3,i}:=[B*(yᵢ [symbol] ₊ [symbol] ₎As+B₁₂*(yᵢ [symbol] _{(i),} [symbol] _{for} i∈[m],

sk_{y}:=(y,k₁,k₂,{k_{3,i}}_{i∈[m]}). [Math 62]

Dec (pk, ctₓ, sk_{y}): The decryption algorithm Dec takes a public key pk, cyphertext ctₓ, and a private key sk_{y} as inputs, calculates b from x and y by the aforementioned expression (3), and then outputs ⊥ indicating a decryption failure when f(b)=0. On the other hand, when f(b)≠0, the decryption algorithm Dec calculates a set S⊆{i|bᵢ=1} that satisfies

WBr=Σ_{i∈S}wᵢ [Math 63]

and outputs a common key L′ as follows.

$$\begin{matrix}[ Math 64 ] & \\ \begin{matrix}{D}_{1 , j} := e ( {{\sum }_{π ( i ) = j}}_{i ∈ {S}_{1}} {c}_{3 , i} + {{\sum }_{π ( i ) = j}}_{i ∈ {S}_{0}} \frac{1}{{x}_{i} - {y}_{{ϕ}^{- 1} ( φ ( i ) )}} ( {y}_{{ϕ}^{- 1} ( φ ( i ) )} {c}_{3 , i , 1} + {c}_{3 , i , 2} ) , {k}_{1} ) , \\ {D}_{2 , j} := e ( {{\sum }_{π ( i ) = j}}_{i ∈ {S}_{1}} {k}_{3 , {ϕ}^{- 1} ( ψ ( i ) )} + {{\sum }_{π ( i ) = j}}_{i ∈ {S}_{0}} \frac{1}{{x}_{i} - {y}_{{ϕ}^{- 1} ( ψ ( i ) )}} {k}_{3 , {ϕ}^{- 1} ( ψ ( i ) )} , {c}_{2 , j} ) for j ∈ [ d ] , \\ {L}^{′} := {H}_{2} ( e ( {k}_{2} , {c}_{1} ) / {\prod }_{j ∈ [ d ]} ( {D}_{1 , j} / {D}_{2 , j} ) )\end{matrix} & \end{matrix}$$

Here, S₁:=S∩{i|t(i)=1}, S₀:=S∩{i|t(i)=0}.

<Overall Configuration of Encryption System 1>

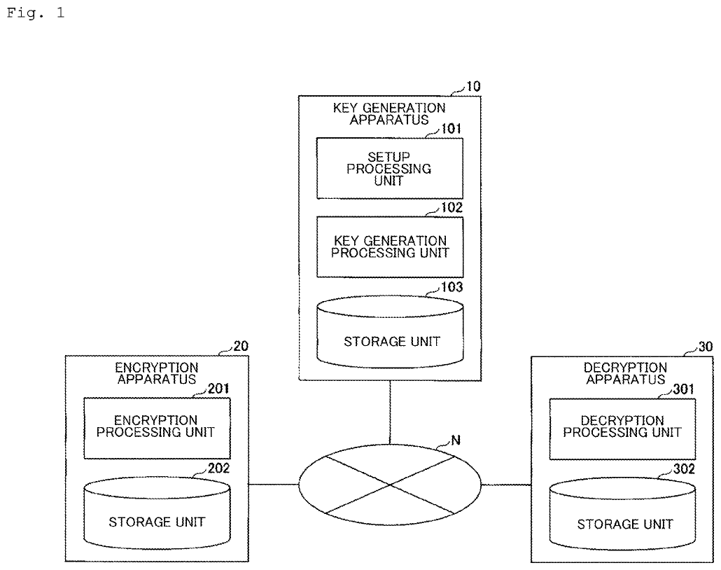

Next, with reference to FIG. 1, an overall configuration of the encryption system 1 will be described that implements “key-policy attribute-based encryption according to the present embodiment”, “ciphertext-policy attribute-based encryption according to the present embodiment”, “key-policy attribute-based KEM according to the present embodiment”, and “cyphertext-policy attribute-based KEM according to the present embodiment”, which have been described above. FIG. 1 is a diagram showing an example of the overall configuration of the encryption system 1 according to the present embodiment.

As shown in FIG. 1, the encryption system 1 according to the present embodiment includes a key generation apparatus 10, an encryption apparatus 20, and a decryption apparatus 30. These apparatuses are connected to one another in a communication-enabled manner via, for example, a communication network N, such as the Internet. Note that although the example of FIG. 1 depicts a case where one encryption apparatus 20 and one decryption apparatus 30 exist, the number of these apparatuses may be more than one each. Furthermore, the number of the key generation apparatus 10 may be more than one as well.

The key generation apparatus 10 is a computer or a computer system that generate a key by executing the setup algorithm Setup and the key generation algorithm KeyGen. Here, the key generation apparatus 10 includes a setup processing unit 101, a key generation processing unit 102, and a storage unit 103. Note that the setup processing unit 101 and the key generation processing unit 102 are implemented by processing that one or more programs installed in the key generation apparatus 10 causes a processor and the like to execute. Furthermore, the storage unit 103 can be implemented using, for example, various types of memories, such as an auxiliary storage device.

The setup processing unit 101 executes the setup algorithm Setup. The key generation processing unit 102 executes the key generation algorithm KeyGen. The storage unit 103 stores various types of data (e.g., a public key pk, a master private key msk, and the like output by the setup algorithm Setup).

The encryption apparatus 20 is a computer or a computer system that generates cyphertext by executing the encryption algorithm Enc. Here, the encryption apparatus 20 includes an encryption processing unit 201 and a storage unit 202. The encryption processing unit 201 is implemented by processing that one or more programs installed in the encryption apparatus 20 causes a processor and the like to execute. Furthermore, the storage unit 202 can be implemented using, for example, various types of memories, such as an auxiliary storage device.

The encryption processing unit 201 executes the encryption algorithm Enc. The storage unit 202 stores various types of data (e.g., data input to the encryption algorithm Enc and the like).

The decryption apparatus 30 is a computer or a computer system that decrypts cyphertext by executing the decryption algorithm Dec. Here, the decryption apparatus 30 includes a decryption processing unit 301 and a storage unit 302. The decryption processing unit 301 is implemented by processing that one or more programs installed in the decryption apparatus 30 causes a processor and the like to execute. Furthermore, the storage unit 302 can be implemented using, for example, various types of memories, such as an auxiliary storage device.

The decryption processing unit 301 executes the decryption algorithm Dec. The storage unit 302 stores various types of data (e.g., data input to the decryption algorithm Dec, data output from the decryption algorithm Dec, and the like).

Note that the configuration of the encryption system 1 shown in FIG. 1 is an example, and another configuration may be used. For example, the encryption apparatus 20 and the decryption apparatus 30 may be implemented in the same apparatus. In this case, this apparatus includes, for example, the encryption processing unit 201, the decryption processing unit 301, and a storage unit.

<Flow of Processing Executed by Encryption System 1>

The following describes a flow of processing executed by the encryption system 1 according to the present embodiment.

Key-Policy Attribute-Based Encryption According to Present Embodiment

When the encryption system 1 according to the present embodiment implements “key-policy attribute-based encryption according to the present embodiment”, the following Step 1-1 to Step 1-4 are executed.

(Step 1-1) The setup processing unit 101 of the key generation apparatus 10 executes the setup algorithm Setup of key-policy attribute-based encryption according to the present embodiment. As a result, a public key pk and a master private key msk are generated and output. These public key pk and master private key msk are stored in the storage unit 103. Also, the public key pk is made public.

(Step 1-2) The encryption processing unit 201 of the encryption apparatus 20 takes the public key pk, an attribute x, and a message M as inputs, and executes the encryption algorithm Enc of key-policy attribute-based encryption according to the present embodiment. As a result, cyphertext ctₓ with an attribute is output. The cyphertext ctₓ with the attribute is transmitted to the decryption apparatus 30 via, for example, the communication network N. The cyphertext ctₓ with the attribute may be stored in the storage unit 202.

(Step 1-3) The key generation processing unit 102 of the key generation apparatus 10 takes the public key pk, the master private key msk, and a policy y as inputs, and executes the key generation algorithm KeyGen of key-policy attribute-based encryption according to the present embodiment. As a result, a private key sk_{y} with a policy is generated. The private key sk_{y} with the policy is transmitted to the decryption apparatus 30 via, for example, the communication network N.

(Step 1-4) The decryption processing unit 301 of the decryption apparatus 30 takes the public key pk, the cyphertext ctₓ with the attribute, and the private key sk_{y} with the policy as inputs, and executes the decryption algorithm Dec of key-policy attribute-based encryption according to the present embodiment. As a result, ⊥ indicating a decryption failure or a message M′ is output. This output result is stored in, for example, the storage unit 302.

Ciphertext-Policy Attribute-Based Encryption According to Present Embodiment

When the encryption system 1 according to the present embodiment implements “ciphertext-policy attribute-based encryption according to the present embodiment”, the following Step 2-1 to Step 2-4 are executed.

(Step 2-1) The setup processing unit 101 of the key generation apparatus 10 executes the setup algorithm Setup of ciphertext-policy attribute-based encryption according to the present embodiment. As a result, a public key pk and a master private key msk are generated and output. These public key pk and master private key msk are stored in the storage unit 103. Also, the public key pk is made public.

(Step 2-2) The encryption processing unit 201 of the encryption apparatus 20 takes the public key pk, a policy x, and a message M as inputs, and executes the encryption algorithm Enc of ciphertext-policy attribute-based encryption according to the present embodiment. As a result, cyphertext ctₓ with a policy is output. The cyphertext ctₓ with the policy is transmitted to the decryption apparatus 30 via, for example, the communication network N. The cyphertext ctₓ with the policy may be stored in the storage unit 202.

(Step 2-3) The key generation processing unit 102 of the key generation apparatus 10 takes the public key pk, the master private key msk, and an attribute y as inputs, and executes the key generation algorithm KeyGen of ciphertext-policy attribute-based encryption according to the present embodiment. As a result, a private key sk_{y} with an attribute is generated. The private key sk_{y} with the attribute is transmitted to the decryption apparatus 30 via, for example, the communication network N.

(Step 2-4) The decryption processing unit 301 of the decryption apparatus 30 takes the public key pk, the cyphertext ctₓ with the policy, and the private key sk_{y} with the attribute as inputs, and executes the decryption algorithm Dec of ciphertext-policy attribute-based encryption according to the present embodiment. As a result, ⊥ indicating a decryption failure or a message M′ is output. This output result is stored in, for example, the storage unit 302.

Key-Policy Attribute-Based KEM According to Present Embodiment

When the encryption system 1 according to the present embodiment implements “key-policy attribute-based KEM according to the present embodiment”, the following Step 3-1 to Step 3-4 are executed.

(Step 3-1) The setup processing unit 101 of the key generation apparatus 10 executes the setup algorithm Setup of key-policy attribute-based KEM according to the present embodiment. As a result, a public key pk and a master private key msk are generated and output. These public key pk and master private key msk are stored in the storage unit 103. Also, the public key pk is made public.

(Step 3-2) The encryption processing unit 201 of the encryption apparatus 20 takes the public key pk and an attribute x as inputs, and executes the encryption algorithm Enc of key-policy attribute-based KEM according to the present embodiment. As a result, cyphertext ctₓ with an attribute and a common key L are output. The cyphertext ctₓ with the attribute is transmitted to the decryption apparatus 30 via, for example, the communication network N. The cyphertext ctₓ with the attribute may be stored in the storage unit 202. Also, the common key L is stored in the storage unit 202.

(Step 3-3) The key generation processing unit 102 of the key generation apparatus 10 takes the public key pk, the master private key msk, and a policy y as inputs, and executes the key generation algorithm KeyGen of key-policy attribute-based KEM according to the present embodiment. As a result, a private key sk_{y} with a policy is generated. The private key sk_{y} with the policy is transmitted to the decryption apparatus 30 via, for example, the communication network N.

(Step 3-4) The decryption processing unit 301 of the decryption apparatus 30 takes the public key pk, the cyphertext ctₓ with the attribute, and the private key sk_{y} with the policy as inputs, and executes the decryption algorithm Dec of key-policy attribute-based KEM according to the present embodiment. As a result, ⊥ indicating a decryption failure or a common key K′ is output. This output result is stored in, for example, the storage unit 302.

Cyphertext-Policy Attribute-Based KEM According to Present Embodiment

When the encryption system 1 according to the present embodiment implements “cyphertext-policy attribute-based KEM according to the present embodiment”, the following Step 4-1 to Step 4-4 are executed.

(Step 4-1) The setup processing unit 101 of the key generation apparatus 10 executes the setup algorithm Setup of cyphertext-policy attribute-based KEM according to the present embodiment. As a result, a public key pk and a master private key msk are generated and output. These public key pk and master private key msk are stored in the storage unit 103. Also, the public key pk is made public.

(Step 4-2) The encryption processing unit 201 of the encryption apparatus 20 takes the public key pk and a policy x as inputs, and executes the encryption algorithm Enc of cyphertext-policy attribute-based KEM according to the present embodiment. As a result, cyphertext ctₓ with a policy and a common key L are output. The cyphertext ctₓ with the policy is transmitted to the decryption apparatus 30 via, for example, the communication network N. The cyphertext ctₓ with the policy may be stored in the storage unit 202. Also, the common key L is stored in the storage unit 202.

(Step 4-3) The key generation processing unit 102 of the key generation apparatus 10 takes the public key pk, the master private key msk, and an attribute y as inputs, and executes the key generation algorithm KeyGen of ciphertext-policy attribute-based KEM according to the present embodiment. As a result, a private key sk_{y} with an attribute is generated. The private key sk_{y} with the attribute is transmitted to the decryption apparatus 30 via, for example, the communication network N.

(Step 4-4) The decryption processing unit 301 of the decryption apparatus 30 takes the public key pk, the cyphertext ctₓ with the policy, and the private key sk_{y} with the attribute as inputs, and executes the decryption algorithm Dec of ciphertext-policy attribute-based KEM according to the present embodiment. As a result, ⊥ indicating a decryption failure or a common key L′ is output. This output result is stored in, for example, the storage unit 302.

<Hardware Configuration of Key Generation Apparatus 10, Encryption Apparatus 20, and Decryption Apparatus 30>

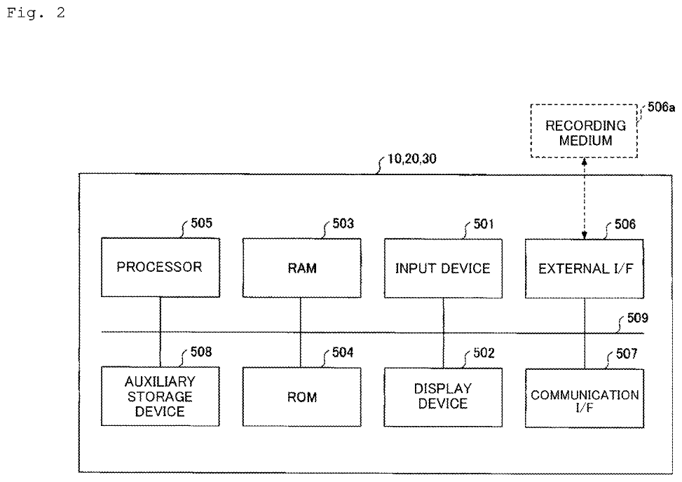

Next, with reference to FIG. 2, a hardware configuration of the key generation apparatus 10, the encryption apparatus 20, and the decryption apparatus 30 included in the encryption system 1 according to the present embodiment, will be described. FIG. 2 is a diagram showing an example of the hardware configuration of the key generation apparatus 10, the encryption apparatus 20, and the decryption apparatus 30 according to the present embodiment. Note that as the key generation apparatus 10, the encryption apparatus 20, and the decryption apparatus 30 according to the present embodiment can be implemented by similar hardware configurations, the following mainly describes the hardware configuration of the key generation apparatus 10.

As shown in FIG. 2, the key generation apparatus 10 according to the present embodiment includes an input device 501, a display device 502, a RAM (Random Access Memory) 503, a ROM (Read Only Memory) 504, a processor 505, an external I/F 506, a communication I/F 507, and an auxiliary storage device 508. These items of hardware are connected to one another in a communication-enabled manner via a bus 509.

The input device 501 is, for example, a keyboard, a mouse, a touchscreen, and the like. The display device 502 is, for example, a display and the like. Note that the key generation apparatus 10, the encryption apparatus 20, and the decryption apparatus 30 may not include at least one of the input device 501 and the display device 502.

The RAM 503 is a volatile semiconductor memory that temporarily holds programs and data. The ROM 504 is a nonvolatile semiconductor memory that can hold programs and data even when the power is OFF. The processor 505 is, for example, a CPU (Central Processing Unit) and the like, and is a computation device that reads programs and data from the ROM 504, the auxiliary storage device 508, and the like into the RAM 503 and executes processing.

The external I/F 506 is an interface with an external apparatus. Examples of the external device include a recording medium 506a, such as a CD (Compact Disc), a DVD (Digital Versatile Disk), an SD memory card (Secure Digital memory card), a USB (Universal Serial Bus) memory card, and the like.

The communication I/F 507 is an interface for connecting to a communication network and communicating with another apparatus. The auxiliary storage device 508 is, for example, a nonvolatile storage device, such as an HDD (Hard Disk Drive) and an SSD (Solid State Drive).

The key generation apparatus 10, the encryption apparatus 20, and the decryption apparatus 30 according to the present embodiment have the hardware configuration shown in FIG. 2, and thus can implement various types of processing by executing each of the aforementioned algorithms. Note that although FIG. 2 shows a case in which the key generation apparatus 10, the encryption apparatus 20, and the decryption apparatus 30 according to the present embodiment are implemented by one apparatus (computer), no limitation is intended by this. The key generation apparatus 10, the encryption apparatus 20, and the decryption apparatus 30 according to the present embodiment may be implemented by a plurality of apparatuses (computers). Furthermore, one apparatus (computer) may include a plurality of processors 505 and a plurality of memories (e.g., RAMs 503, ROMs 504, and auxiliary storage devices 508).

### SUMMARY

As described above, the encryption system 1 according to the present embodiment can implement “key-policy attribute-based encryption according to the present embodiment”, “ciphertext-policy attribute-based encryption according to the present embodiment”, “key-policy attribute-based KEM according to the present embodiment”, and “cyphertext-policy attribute-based KEM according to the present embodiment”. These encryption methods and KEM methods are based on techniques configuring a method called FAME, which is efficient but has low expressiveness compared to the OT method. See, for example, a document “S. Agrawal and M. Chase. FAME: Fast attribute-based message encryption. In ACM CCS, 2017.” for the details of FAME.

While FAME is an efficient configuration, FAME cannot use NOT in a conditional expression that expresses a policy. In contrast, the encryption methods according to the present embodiment (and the KEM methods that use the application of these encryption methods) are designed so as to allow NOT in a conditional expression and multiple appearances of attribute labels while retaining the characteristics where efficient operations are performed with reference to the structure of FAME. In this way, the encryption system 1 according to the present embodiment can implement attribute-based encryption (and KEM that uses this attribute-based encryption) which can use an arbitrary conditional expression as a policy without increasing the sizes of cyphertext and a private key, and which is efficient.

More specifically, in attribute-based encryption implemented by the encryption system 1 according to the present embodiment (and KEM that uses this attribute-based encryption), first of all, the number of group elements of the cyphertext and the private key is smaller compared to the OT method, and thus, the number of exponentiation calculations, which are relatively heavy calculations upon encryption and key generation, can be significantly reduced. Therefore, the calculation time for encryption and key generation can be reduced.

Furthermore, second, the number of pairing calculations, which are heavy calculations necessary upon decryption, is significantly reduced as well, and thus, decryption is also performed at a higher speed compared to the OT method. Especially, although the number of pairing calculations depends on a policy to be used, decryption can be performed at a speed that is faster by a factor equivalent to the number of variables of this policy or greater. For example, in a case where decryption processing is performed using cyphertext or a private key with a policy composed of 20 variables, speeding up of 20 times or greater can be achieved.

Furthermore, attribute-based encryption implemented by the encryption system 1 according to the present embodiment (and KEM that uses this attribute-based encryption) can use an arbitrary conditional expression as a policy without increasing the sizes of cyphertext and the key. That is to say, attribute labels may appear any number of times in a conditional expression.

The present invention is not limited to the foregoing embodiment that has been specifically disclosed, and a variety of modifications and changes can be made thereto without departing from the description of claims.

### REFERENCE SIGNS LIST

1 Encryption system
10 Key generation apparatus
20 Encryption apparatus
30 Decryption apparatus
101 Setup processing unit
102 Key generation processing unit
103 Storage unit
201 Encryption processing unit
202 Storage unit
301 Decryption processing unit
302 Storage unit

1. An encryption system, comprising:
one or more computers each including a memory and a processor configured to generating a public key and a master private key that are used in attribute-based encryption;
using, as inputs, at least the public key and one of an attribute and a policy that is denoted by an arbitrary conditional expression related to the attribute, and generating at least cyphertext in which one of the attribute and the policy is embedded;
using the public key, the master private key, and the other of the attribute and the policy as inputs, and generating a private key in which the other of the attribute and the policy is embedded; and
using the public key, the cyphertext, and the private key as inputs, and decrypting the cyphertext.

2. A key generation apparatus, comprising:
a memory and a processor configured to generating a public key and a master private key that are used in attribute-based encryption; and
using, as inputs, the public key, the master private key, and one of an attribute and a policy that is denoted by an arbitrary conditional expression related to the attribute, and generating a private key in which one of the attribute and the policy is embedded.

3-4. (canceled)

5. A method executed by a computer including a memory and a processor, the method comprising:
generating a public key and a master private key that are used in attribute-based encryption;
an encryption procedure of using, as inputs, at least the public key and one of an attribute and a policy that is denoted by an arbitrary conditional expression related to the attribute, and generating at least cyphertext in which one of the attribute and the policy is embedded;
using the public key, the master private key, and the other of the attribute and the policy as inputs, and generating a private key in which the other of the attribute and the policy is embedded; and
using the public key, the cyphertext, and the private key as inputs, and decrypting the cyphertext.

6. A non-transitory computer-readable recording medium having computer-readable instructions stored thereon, which when executed, cause a computer including a memory and a processor to execute respective operations in the encryption system according to claim 1 or respective operations in the key generation apparatus according to claim 2.
